(19) United States
(12) Patent Application Publication
(10) Pub. No.: US 2013/0273431 A1
(43) Pub. Date: Oct. 17, 2013

(54) VANADIUM OXIDE CATHODE MATERIAL

(71) Applicant: Jian Xie, Carmel, IN (US)

(72) Inventor: Jian Xie, Carmel, IN (US)

(21) Appl. No.: 13/827,778

(22) Filed: Mar. 14, 2013

Related U.S. Application Data
(60) Provisional application No. 61/623,318, filed on Apr. 12, 2012.
(60) Provisional application No. 61/707,245, filed on Sep. 28, 2012.

(51) Int. Cl. H01M 4/131

(52) U.S. Cl. CPC H01M 4/131
USPC 429/231.5; 252/506

(57) ABSTRACT

An electrode, including a polymer matrix and a plurality of graphene-vanadium pentoxide composite materials dispersed in the polymer matrix. Each respective graphene-vanadium pentoxide particle includes a vanadium pentoxide substrate wrapped in a respective graphene monolayer sheet, each respective monolayer sheet is bonded to a respective vanadium pentoxide substrate, and wherein each respective vanadium pentoxide substrate is about 1 to about 100 nm long.

### CROSS REFERENCE

This application claims priority to copending U.S. provisional patent application Ser. No. 61/623318, filed on Apr. 12, 2012, and to U.S. provisional patent application Ser. No. 61/707245, filed on Sep. 28, 2012.

### TECHNICAL FIELD

The present novel technology relates generally to electrochemistry and, more particularly, to graphene-vanadium oxide aerogel composites as cathodes for Li-ion batteries.

### BACKGROUND

The need for alternative fuel sources has grown over the last twenty years, due in part, to the rise of oil prices. As world population continues to grow so will the need to develop more efficient vehicles that require fewer natural resources. Since the late 1990s, advancements in battery technologies have driven the possibility of ending a vehicle's need for liquid fuel. These advancements still face strong opposition due to their high cost, limited range, and weight parity issues in comparison to the traditional oil based fuel. In addition the traditional Li-ion batteries typically have short cycle lives and show significant degradation issues with age. These limitations have shown to be a hindrance to the development of the alternative fuel sources.

Additional problems in the field of Li-ion batteries have become more apparent as the search continues for an alternative fuel source. The driving range of electric vehicles (EVs) and the fuel economy of hybrid electric vehicles (HEVs) are limited by the specific energy of Li-ion batteries (LIBs). Current state-of-the-art LIBs can achieve only 250 Wh/kg with prismatic cell configuration. The specific energy of LIB cells are limited by both the anode (e.g. graphite, 372 mAh/g) and the cathode (e.g. LiNiO₂, 180 mAh/g). Rechargeable lithium metal electrodes have remained a major challenge for high specific energy anodes for decades due to internal-shorting caused by dendrite formation.

Alternative materials, such as V₂O₅, have been studied as a replacement for the current cathode materials due to its high specific capacity, but V₂O₅ has not been considered practical for use in batteries due to performance issues arising from its low electronic conductivity. The challenge is to improve e⁻ conductivity, not only the interparticle but also intraparticle. The major technical risks associated with this improvement must address (1) the cycle life of the rechargeable Li metal anode, which is targeted to at least 1000 cycles, and (2) the capacity and cycle life of a nanostructured V₂O₅/graphene composite. The present novel technology addresses this need.

### BRIEF DESCRIPTION OF DRAWINGS

FIG. 1 is an illustration of an V₂O₅ aerogel nanorod cathode material according to a first embodiment of the present novel technology.

FIG. 2 is an illustration the cathode material of FIG. 1 in a Li/V₂O₅ battery cell.

FIG. 3 is an illustration of the material of FIG. 1 in a graphene-V₂O₅ composite.

FIG. 4 is an illustration of a graphene sheet wrapped around a V₂O₅ nanorod of FIG. 1.

FIG. 5 schematically illustrates the synthesis of the novel electrode material of FIG. 1.

FIG. 6 is a graph representing the first cycle of the V₂O₅ aerogel doped with 1% graphene as used in FIG. 2.

### DETAILED DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

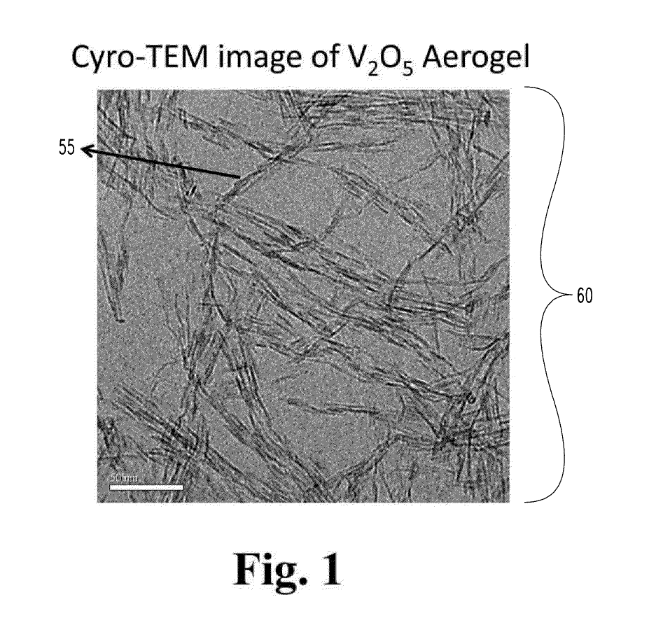

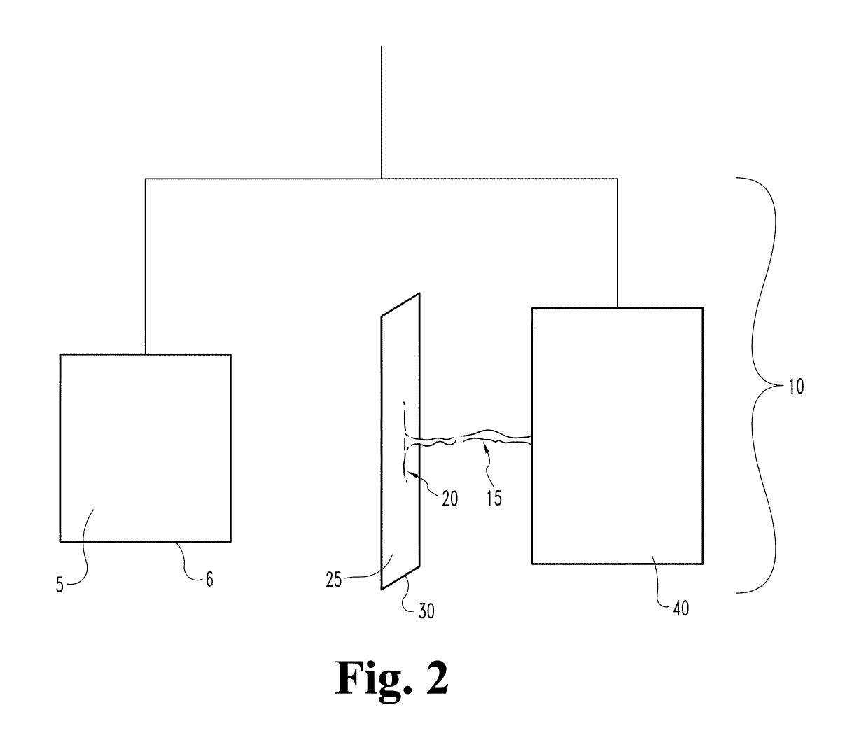

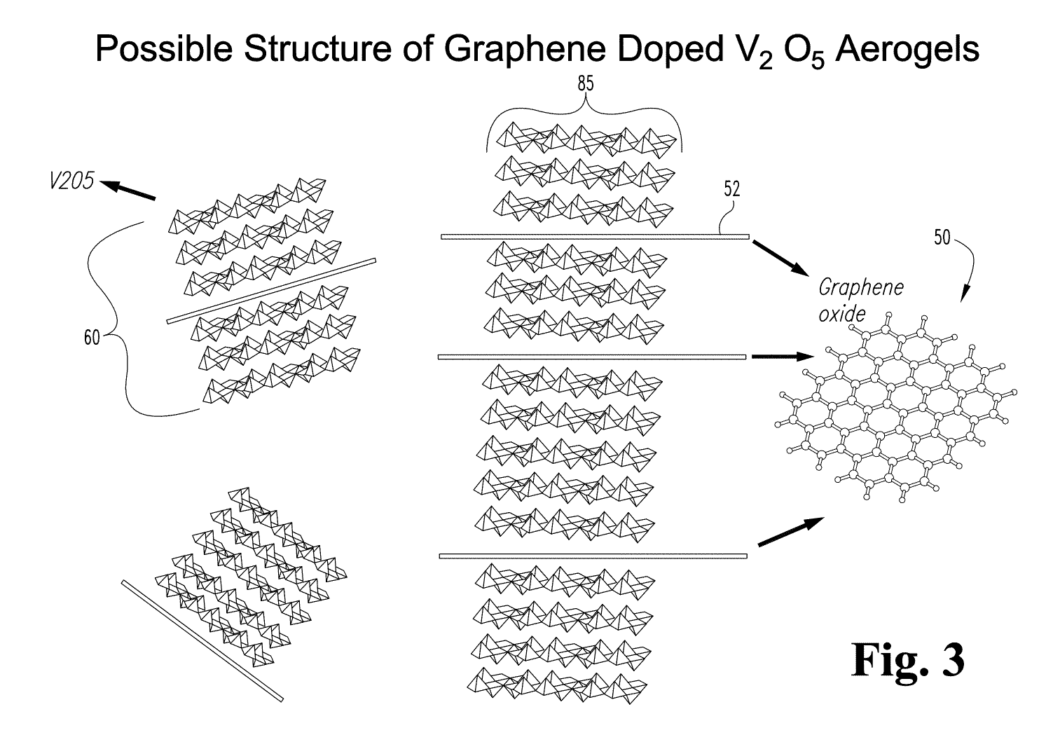

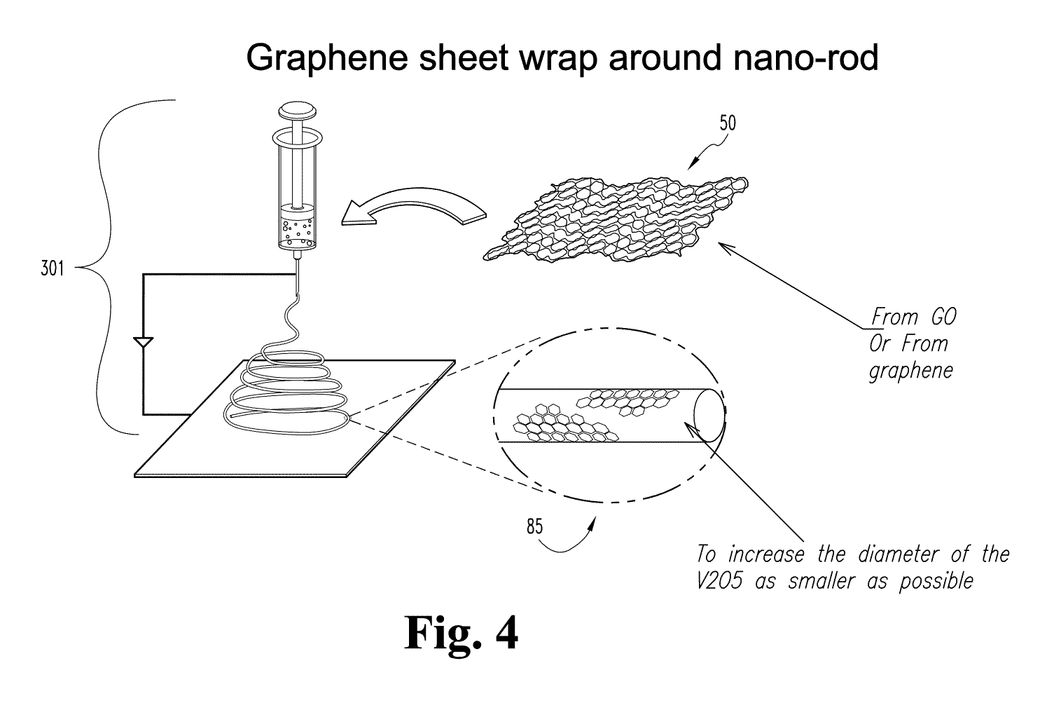

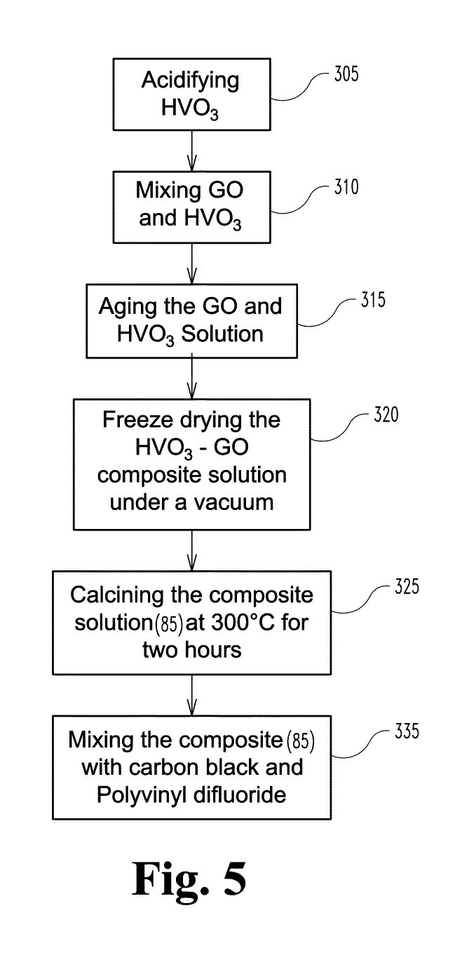

Referring now to FIGS. 1-6, a first embodiment of the present novel technology is shown, illustrating vanadium pentoxide as a cathode material 5 for Li-ion batteries 10, and a method for the synthesis thereof. There is typically a reversible electrochemical lithium intercalation and deintercalation between adjacent layers of V₂O₅ at room temperature. Typically, compared to crystalline V₂O₅, a higher Li⁺-ion intercalation capacity may be obtained in amorphous phases, such as the hydrated form of vanadium pentoxide (V₂O₅.nH₂O), aerogels and xerogels 60, or the like. V₂O₅ xerogels 60 may react with 4 Li per mole of V₂O₅; and the insertion of up to 5.8 moles of Li may occur for aerogels 60 corresponding to capacities of 560 and 650 mAhg⁻¹, which is typically higher than those of LiFePO₄ cathodes. However, the moderate electrical conductivity of V₂O₅ and the low diffusion coefficient of Li-ions in a V₂O₅ matrix may decrease the intercalation capacity and charge/discharge rate of the materials. Moreover, the V₂O₅ is prone to limitations of its long-term cycling stability. Due to its high conductivity, graphene is selected as a component in a V₂O₅-carbon composite 85 for electrode materials 5. Graphene is selected as a carbon source to prepare V₂O₅ composites 85. The cathode material 5 typically achieves excellent charge/discharge performance and electrochemical stability by selecting graphene-V₂O₅ composites 85 prepared by using a sol-gel process 301. The cathode material 5 addresses technical challenges including a rechargeable Lithium anode 40, and a high specific energy and high rate V₂O₅ cathode 6. The cathode material 5 results in a Li/V₂O₅ battery system 10 with a Li metal anode 40 typically exhibiting at least about 1000 Wh/kg and 1000 cycles at 1 C rate and room temperature demonstrated in the pouch cell configuration.

Internal shorting is typically an issue with conventional Li metal electrodes due to dendrite formation. The novel cathode material 5 allows control over the direction of dendrite growth to overcome the cells internal short circuiting. Dendrites 15 initially grow toward each other in the through-plane direction (simultaneously starting from the Li metal surface and from the separator surface), contact each other, stop growth in the through-plane direction but continue growth in the in-plane direction, and eventually form a Li metal layer that prevents the internal-shorting. A carbon layer 20 with immobilized Li⁺-ions as seeds on the separator surface 25 is formed. These Li⁺-ions induce the Li dendrites 15 to grow on the coated separator surface 25, and eventually the dendrites 15 cancel each other out.

In one embodiment (not shown), a coin cell consisting of Li metal anode and a LiFePO₄ cathode may reach seven hundred twenty five cycles with eighty percent initial capacity by coating a carbon layer or sheet on the surface of the separator, which does not require extraneous changes to the configuration or components of the current batteries and does not incur any significant additional use of resources.

In another embodiment, the cathode material 5 improves e⁻ conductivity (via both the interparticles and intraparticles) by wrapping a carbon sheet 50, typically a single-atomic-layer-thick graphene sheet 50 around a V₂O₅ substrate 55, typically a nanorod and/or nanofiber 55, which effectively improves the interparticle e⁻ conductivity. To improve the intraparticle e⁻ conductivity, the graphene sheet 50 may wrap around the basic building blocks of the V₂O₅ aerogel 60. In one example, the nanorod 55 may be about 1 nm wide and about 100 nm long. For a V₂O₅ nanofiber and/or nanorod 55 synthesized through electrospinning, the nanorod 55 diameter may be reduced to the nanoscale (from the micro scale), so that the graphene wrap 70 may enhance the interparticle e⁻ conductivity. The intraparticle e⁻ conductivity may be improved by introducing the graphene oxide sheet 50 into a sub-nanometer unit of the V₂O₅ aerogel 60 and incorporating it into the precursor solution for electrospinning. The graphene sheet wrap 70 may increase the e⁻ conductivity because graphene has a high e⁻ conductivity and high mechanical strength, which can constrain the volume expansion of the V₂O₅ nanorod and/or nanofiber 55 when the Li⁺-ion is inserted. Enhancing the e⁻ conductivity of the V₂O₅ is desired for maintaining rate performance while constraining the expansion is desired for maintaining cycle life. One way of wrapping the graphene sheet 50 around the V₂O₅ nanorod and/or fiber 55 is to anchor the graphene sheet 50 onto the surface of the nanorod and/or fiber 55, which requires the establishment of an interaction or weak bond between the graphene sheet 50 and the V₂O₅ nanorod and/or fiber 55.

In one embodiment, a graphene oxide solution 80 is used, which possesses a considerable number of hydroxyl and epoxide functional groups on both surfaces of the graphene sheet 50 and also includes carboxyl groups, mostly at the sheet edges 52. These partial charges/lone unpaired e⁻ of the surface groups may easily establish weak bonds with charges on the surface of the V₂O₅ through a Columbic force, causing the graphene sheet 50 to wrap around the nanorod 55 and/or fiber 55.

To this end, various approaches may be taken, including: wrapping the graphene sheets 50 (synthesized through the sol-gel process 301) around the V₂O₅ aerogel nanorod and/or nanofiber 55 wrapping graphene sheets 50 (synthesized through electrospinning 201) around the V₂O₅ nanorods and/or fibers 55 or the like.

In one example, the graphene oxide solution 60 is first prepared 300 using a modified Hummer's method, or the like. HVO₃ is formed 305 by the acidification of a sodium vanadate solution (by passing it down an acidified ion-exchange column). GO and HVO₃ are mixed 310, aged 315 for two weeks, and freeze-dried under a vacuum 320. The gels or composite solutions are calcined 325 at a temperature of at least three hundred degrees Celsius in nitrogen for two hours. The working electrodes are prepared 335 by mixing the graphene-V₂O₅ composite 85, carbon black and Polyvinyl difluoride with the weight ratio of 8:1:1. The discharge and charge measurements are conducted 340 with a commercially available battery tester.

The addition of graphene may increase the electrochemical performance of the V₂O₅ aerogel 60. For as-prepared 2 wt. % graphene-V₂O₅ aerogels, 3 wt. % graphene-V₂O₅ aerogels, and 4 wt. % graphene-V₂O₅ aerogels, the materials deliver discharge capacities of approximately 182, 304, and 189 mAh−1, respectively. Importantly, when 1 wt. % graphene has been loaded into the V₂O₅ aerogel, the initial capacity is as high as 380 mAhg−1, as compared to the bare V₂O₅ aerogel with 166 mAhg−1.

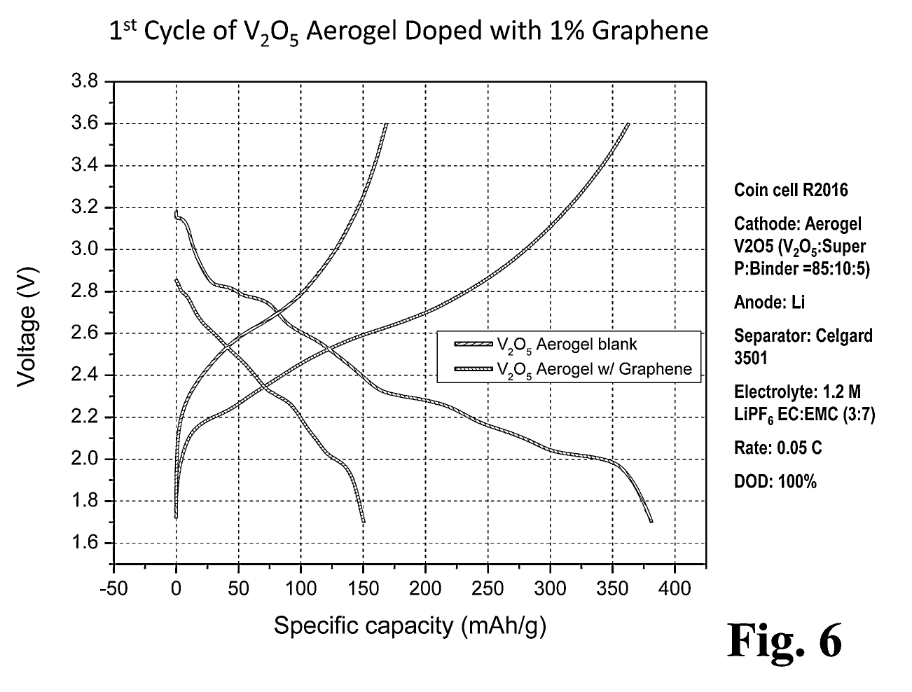

As shown in FIG. 6, the 1 wt. % graphene-V₂O₅ shows an excellent rate capacity. At rates of 1 C, 2 C, 3 C, 5 C, and 10 C, the materials may comprise of capacities of approximately 307, 283, 358, 227, and 171 mAhg−1, respectively. The prior maximum value ever reported in the literature for rate performance.

The 1 wt. % graphene-V₂O₅ aerogels typically have high cycling stability. The initial discharge capacities of the composite are 307 mAhg−1, respectively, when cycled between 2V to 3.8V at 1 C rate. The three hundredth discharge capacities decreased to 150 mAhg−1, while the capacity retention is still as high as fifty percent for the composite. The electrochemical performance may be attributed to the incorporation of the graphene sheet 50 in the V₂O₅ nanostructure, which significantly enhances the conductivity and stability of the V₂O₅ aerogel 60, consequently enhancing the capacity, rate performance, and cycle life.

In some embodiments, the graphene-V₂O₅ aerogel composites 85 are synthesized via a sol-gel process 301, and its electrochemical properties may be investigated for Li-ion intercalation applications. The electrochemical analysis shows that 1 wt. % graphene-V₂O₅ aerogels delivers a high initial capacity of 380 mAhg−1. Compared with bare V₂O₅ aerogels, the incorporation of graphene increases the capacity, rate performance, and cycle life of the composites.

### Example 1

The driving range of electric vehicles (EVs) and the fuel economy of hybrid electric vehicles (HEVs) are limited by the specific energy of Li-ion batteries (LIBs). Current state-of-the-art LIBs can achieve only 250 Wh/kg with prismatic cell configuration. The specific energy of LIB cells is limited by both the anode (e.g. graphite, 372 mAh/g) and the cathode (e.g. LiNiO₂, 180 mAh/g). We propose to develop a at least 1000 Wh/kg Li/V₂O₅ battery system, consisting of a Li metal anode and a V₂O₅ cathode with theoretical specific capacities of 3860 mAh/g and 442 mAh/g, respectively. The theoretical specific energy of this Li/V₂O₅ cell is 1326 Wh/kg. Two major technical challenges are (1) a rechargeable Lithium anode, and (2) a high specific energy and high rate V₂O₅ cathode. The deliverable of this project is a Li/V₂O₅ battery system with at least 1000 Wh/kg and 1000 cycles at 1 C rate and room temperature demonstrated in the pouch cell configuration.

### Example 2

Rechargeable lithium metal electrodes have remained a major challenge for high specific energy anodes for decades due to internal-shorting caused by dendrite formation. The approach we are taking to overcome this challenge is to control the direction of the dendrite growth so the dendrites initially grow toward each other in the through-plane direction (simultaneously starting from the Li metal surface and from the separator surface), touch each other, stop growth in through-plane direction but start growth in an in-plane direction, eventually form a Li metal layer that prevents the internal shorting. The key to this approach is to form a carbon layer with immobilized Li+ ions as seeds on the separator surface. These Li+ ions induce the Li dendrites to grow on the coated separator surface, and eventually the dendrites cancel each other out. Using such an approach, a coin cell consisting of a Li metal anode and a LiFePO₄ cathode has reached seven hundred and twenty five cycles with 80% initial capacity. The technology uses a simple approach by coating a special carbon layer on the surface of the separator, which does not require changes to the configuration or components of current batteries and does not incur any significant additional cost. In the proposed project, we will focus on increasing cycle life and reducing capacity loss with a target of at least 1000 cycles and 80% initial capacity.

### Example 3

V₂O₅ has been studied as a cathode material for decades because of its high specific capacity, but has not been used in practical batteries due to its poor rate performance caused by its low electronic conductivity. The challenge is to improve e− conductivity not only the interparticle but also intraparticle. The concept we propose is to wrap a single-atomic-layer-thick graphene sheet around the V₂O₅ nanorod and/or nanofiber, which will improve the interparticle e− conductivity. To improve the intraparticle e− conductivity, the graphene sheet wrap around the basic building blocks of the V₂O₅ aerogel: the nanorod (e.g. 1 nm wide and 100 nm long). For a V₂O₅ nanofiber synthesized through electrospinning, the diameter needs to be reduced to the nanoscale so that the graphene wrap can enhance the interparticle e− conductivity. The intraparticle e− conductivity can be improved by introducing the graphene oxide sheet into a sub-nanometer unit of the V₂O₅ aerogel and incorporating it into the precursor solution for electrospinning. The graphene sheet wrap can increase the e− conductivity because graphene has a high e− conductivity and high mechanical strength, which can constrain the volume expansion of the V₂O₅ nanorod/fiber when the Li+ ion is inserted. Enhancing the e− conductivity of the V₂O₅ is critical for rate performance, while constraining the volume expansion is critical for cycle life. The key to wrapping the graphene sheet around the V₂O₅ nanorod and/or fiber is to anchor the graphene sheet onto the surface of the nanorod and/or fiber, which requires the establishment of an interaction or weak bond between the graphene sheet and the V₂O₅ nanorod and/or fiber. We use graphene oxide, which possesses a considerable number of hydroxyl and epoxide functional groups on both surfaces of each sheet and also includes carboxyl groups, mostly at the sheet edges. These partial charges/lone unpaired e− of surface groups can easily establish weak bonds with charges on the surface of the V₂O₅ through a Columbic force, causing the graphene sheet to wrap around the nanorod and/or fiber. Two approaches will be taken: (1) wrap graphene sheets (synthesized through the sol-gel process) around the V₂O₅ aerogel nanorod, and (2) wrap graphene sheets (synthesized through electrospinning) around the V₂O₅ nanofiber/rods.

Successful improvement of the e− conductivity of the V₂O₅ nanorod (aerogel) as demonstrated by a two-fold (2×) performance improvement with the addition of 1 wt. % graphene: from 166 mAh/g to 380 mAh/g (498 Wh/kg to 1140 Wh/kg) at 1/20 C and a three-fold (3×) improvement for nanofiber (electrospinning) with the addition of 2 wt. % graphene: from 116 mAh/g to 350 mAh/g (348 Wh/kg to 1050 Wh/kg) at 1/20 C The nanorod (aerogel) with 1 wt. % graphene shows excellent rate performance as shown in FIG. 6, 307 mAh/g (921 Wh/kg) at 1 C (vs. 380 mAh/g at 1/20 C). There may be an increase in the specific capacity, rate performance, and cycle life with a target of at least 1000 Wh/kg and 1000 cycles (1 C). A focus on (1) reducing the diameter of the V₂O₅ nanorod and/or fiber, (2) wrapping the graphene sheets around the V₂O₅ nanorod and/or fiber, and (3) incorporating a single-atomic-layer-thick graphene sheet into the V₂O₅ nanorod and/or fiber at the nano- or subnano-scale may be desirable. It is possible to synthesize high-surface-area graphene (1800 m2/g) using an oxidation and thermal expansion method, which is cost effective and easy for scale-up. The single-atomic-layer-thick graphene oxide sheet is a first-step product in graphene synthesis and has been observed using high-resolution cryo-TEM.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1) An electrode material for an electrochemical cell comprising:
a vanadium pentoxide substrate; and a carbon sheet at least partially conforming to the substrate; and
wherein at least one atomic layer of carbon chemically bonds with the vanadium pentoxide substrate to define a composite.

2) The electrode material of claim 1 wherein the carbon source is graphene.

3) The electrode material of claim 1 wherein the vanadium pentoxide substrate is a nanorod.

4) The electrode material of claim 1 wherein the vanadium pentoxide is an aerogel.

5) An electrode composition, comprising:
a plurality of vanadium pentoxide substrates;
a plurality of graphene monolayer sheets, each respective sheet wrapped around and bonded to a respective vanadium pentoxide substrate to define a plurality of composite particles;
a carbon powder;
a polymer powder; and
wherein the carbon powder, polymer powder, and composite particles are mixed to define a homogenous electrode material.

6) The electrode composition of claim 5 wherein the plurality of vanadium pentoxide substrates are an aerogel.

7) The composition of claim 5 wherein the weight ration of composite particles, carbon powder, and polymer powder is 8:1:1.

8) A method for preparing a vanadium cathode material:
a) preparing a graphene oxide solution;
b) acidifying a sodium vanadate solution;
c) mixing the graphene oxide solution with the acidified sodium vanadate solution, to define a composite solution;
d) aging the composite solution for about two weeks,
e) freeze drying the composite solution to yield a freeze dried residue;
f) calcining the freeze dried residue;
g) mixing the calcined material with a carbon source and a thermoplastic fluoropolymer to define an electrode material; and
h) forming an electrode from the electrode material.

9) The method of claim 8 wherein the carbon source is carbon black.

10) The method of claim 8 wherein the composite solution is a gel.

11) The method of claim 8 wherein the thermoplastic fluoropolymer is polyvinyl difluoride.

12) The method of claim 8 wherein the weight ratio between the calcined solution, the carbon source, and thermoplastic fluoropolymer is 8:1:1.

13) The method of claim 8 wherein the weight percent of the graphene oxide solution may be varied between 1-4%.

14) The method of claim 8 wherein the freeze dried residue is calcined at a temperature of about three hundred degrees Celsius.

15) The method of claim 8 wherein the freeze dried residue is calcined in nitrogen for about two hours.

16) An electrode, comprising:
a polymer matrix; and
a plurality of graphene-vanadium pentoxide composite materials dispersed in the polymer matrix;
wherein each respective graphene-vanadium pentoxide particle includes a vanadium pentoxide substrate wrapped in a respective graphene monolayer sheet;
wherein each respective monolayer sheet is bonded to a respective vanadium pentoxide substrate; and
wherein each respective vanadium pentoxide substrate is about 1 to about 100 nm long.

17) The electrode of claim 16 wherein the vanadium pentoxide substrate is a nanofiber.

18) The electrode of claim 16 wherein the vanadium pentoxide substrate is an aerogel.
